(19) United States
(12) Patent Application Publication
(10) Pub. No.: US 2026/0039634 A1
(43) Pub. Date: Feb. 5, 2026

(54) SECURE SHARING OF KEY-VALUE CACHE

(71) Applicants: Beijing Volcano Engine Technology Co., Ltd., Beijing (CN); Southern University of Science and Technology, Shenzhen (CN)

(72) Inventors: Guanlong WU, Beijing (CN); Yao ZHANG, Beijing (CN); Yinqian ZHANG, Shenzhen (CN); Zheng ZHANG, Beijing (CN); Ye WU, Beijing (CN)

(21) Appl. No.: 19/256,069

(22) Filed: Jun. 30, 2025

(30) Foreign Application Priority Data
Aug. 1, 2024 (CN) 202411053215.X
Feb. 13, 2025 (CN) 202510162811.X

(51) Int. Cl. H04L 9/40

(52) U.S. Cl. CPC H04L 63/0428; H04L 63/1416

(57) ABSTRACT

According to embodiments of the disclosure, a method, an apparatus, a device and a medium for securely sharing key-value cache of a language model are provided. The method includes: obtaining request content input to a language model; recognizing protected information and non-protected information in the request content; determining, for a first part in the non-protected information whose matched key-value is absent from a shared key-value cache of the language model, a key-value corresponding to the first part and adding the key-value to the shared key-value cache, where a key-value of the protected information is not added to the shared key-value cache.

### CROSS-REFERENCE

The present application claims priority to Chinese Patent Application No. 202510162811.X, filed on Feb. 13, 2025, and entitled “METHOD, APPARATUS, DEVICE AND MEDIUM FOR SECURELY SHARING KEY-VALUE CACHE OF LANGUAGE MODEL”; and Chinese Patent Application No. 202411053215.X, filed on Aug. 1, 2024, and entitled “METHOD AND RELATED DEVICE FOR SECURITY DETECTION OF MODEL SERVICE”, the entireties of which are incorporated herein by reference.

### FIELD

Example embodiments of the present disclosure generally relate to the field of computer technology, and in particular, to secure sharing of key-value cache of a language model, and a method and related device for security detection of a model service.

### BACKGROUND

This section is intended to provide background or context for embodiments of the disclosure set forth in the claims. The description herein is not admitted as related art because of being included in this section.

With the development of computer technologies, electronic devices in various forms can greatly enrich people's daily life. For example, people may utilize an electronic device for various interactions. For example, the user may provide the request content to the electronic device, so that the electronic device processes the request content, and then provides the reply content for the request content to the user.

In order to improve the interaction efficiency, it may be determined whether there is a target key-value matching at least a part of content in the request content in the shared key-value cache corresponding to the language model, and further, the target key-value in the shared key-value cache may be reused to generate the reply content for the request content. How to securely share a key-value cache of a language model is a focal issue of concern.

With continuous development of artificial intelligence technology, model services exhibit superior performance in conversational questioning and answering, text generation, language translation, and the like. During an inference process of the model, a manner of key-value cache (KV cache) sharing is used to save computing time and computing resources of the inference process of the model. However, this manner has a security issue.

### SUMMARY

In a first aspect of the present disclosure, a method for securely sharing key-value cache of a language model is provided. The method includes: obtaining request content input to a language model; recognizing protected information and non-protected information in the request content; determining, for a first part in the non-protected information whose matched key-value is absent from a shared key-value cache of the language model, a key-value corresponding to the first part and adding the key-value to the shared key-value cache, where a key-value of the protected information is not added to the shared key-value cache.

In a second aspect of the present disclosure, an apparatus for securely sharing key-value cache of a language model is provided. The apparatus includes: a first obtaining module configured to obtain request content input to a language model. a first recognizing module configured to recognize protected information and non-protected information in the request content; and a first determining module configured to determine, for a first part in the non-protected information whose matched key-value is absent from a shared key-value cache of the language model, a key-value corresponding to the first part and adding the key-value to the shared key-value cache, where a key-value of the protected information is not added to the shared key-value cache.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, and the computer program is executable by the processor to implement the method of the first aspect.

In a fifth aspect of the present disclosure, a computer program product is provided. The computer program product includes computer-executable instructions that, when executed by a processor, implement the method according to the first aspect of the present disclosure.

It should be understood that the content described in this summary section is not intended to limit the key features or important features of the embodiments of the present disclosure, nor is it intended to limit the scope of the present disclosure. Other features of the present disclosure will become readily understood from the following description.

Embodiments of the present disclosure further provide a method and a related device for security detection of a model service, which at least solve one of the technical problems in the related art to a certain extent.

Based on the above objective, a first aspect of the present disclosure provides a method for security detection of a model service, including: obtaining cache information of a first model service, the cache information generated based on a first request sent to the first model service; and performing security detection on the first model service based on lifetime of the cache information, to obtain a result of security detection for cache sharing of the first model service.

In some embodiments, performing the security detection on the first model service based on the lifetime of the cache information, to obtain the result of the security detection for the cache sharing of the first model service includes: determining, in accordance with that the lifetime of the cache information is extended based on a reason of a user, that the result of security detection for cache sharing of the first model service is a failure.

In some embodiments, the method further includes: obtaining a second request sent by the user to the first model service; and determining, in accordance with that the lifetime of the cache information is extended based on the reason of the user, that the result of security detection for cache sharing of the first model service is the failure. including: obtaining the lifetime of the cache information; determining, in accordance with that the lifetime of the cache information is greater than a preset lifetime threshold, an abnormality cause of the lifetime of the cache information; and determining, in accordance with that the abnormality cause comprises the lifetime of the cache information being extended based on the second request, that the result of security detection for cache sharing of the first model service is the failure.

In some embodiments, the method further includes: determining, in response to the abnormality cause comprising that cache information is not cleared based on a preset clear command, that the result of security detection for cache sharing of the first model service is the failure.

In some embodiments, the method further includes: obtaining a third request sent by a user to the first model service; and performing security detection on the first model service based on return information of the third request, to obtain a result of security detection.

In some embodiments, performing the security detection on the first model service based on the return information of the third request, to obtain the result of security detection includes: obtaining request processing time of the third request; and determining, in accordance with that a number of the third requests belonging to a same user in a first preset period is greater than a first preset number and the corresponding request processing time is less than a preset time threshold, that the result of security detection for cache sharing of the first model service is the failure.

In some embodiments, performing the security detection on the first model service based on the return information of the third request, to obtain the result of the security detection includes: obtaining return information of the third requests belonging to a plurality of users; and determining, in accordance with that an order of return information of the third request belonging to a target user in the plurality of users in a second preset time period is changed and a number of the third requests with an order being changed is greater than a second preset number, that the result of security detection for cache sharing of the first model service is the failure.

In some embodiments, the method further includes: obtaining a fourth request sent by a user to the first model service; and performing security detection on the first model service based on request content of the fourth request, to obtain a result of security detection.

In some embodiments, performing the security detection on the first model service based on the request content of the fourth request, to obtain the result of the security detection includes: obtaining the request content of the fourth request; and determining. in accordance with that in a third preset time period the request content of the fourth requests belonging to a same user is the same or similar, and/or a number of the fourth requests is greater than a third preset number, that the result of security detection for cache sharing of the first model service is the failure.

In some embodiments, performing the security detection on the first model service based on the request content of the fourth request, to obtain the result of the security detection includes: obtaining request content of the fourth request; obtaining a request parameter set by a user in the request content; and determining, in response to the request parameter set by the user satisfying a preset condition, that the result of security detection for cache sharing of the first model service is the failure.

In some embodiments, the request parameter set by the user satisfying the preset condition comprises at least one of: a length of return information of the fourth request being less than a preset value, or cache information generated based on the fourth request not stored in the first model service.

Based on the same inventive concept, a second aspect of the present disclosure provides an apparatus for security detection of a model service, including: an obtaining module configured to obtain cache information of a first model service, the cache information generated based on a first request sent to the first model service; and a detection module configured to perform security detection on the first model service based on lifetime of the cache information, to obtain a result of security detection for cache sharing of the first model service.

Based on the same inventive concept, a third aspect of the present disclosure provides an electronic device. including a memory, a processor, and a computer program being stored on the memory and executable on the processor, the processor, when executes the program, implementing the method of the first aspect.

Based on the same inventive concept, a fourth aspect of the present disclosure provides a non-transitory computer-readable storage medium storing computer instructions for causing the computer to perform the method of the first aspect.

Based on the same inventive concept, a fifth aspect of an example embodiment of the present disclosure provides a computer program product, including a computer program instructions, the computer program instructions, when runs on a computer, causing the computer to perform the method of the first aspect.

As can be seen from the above, the method and related device for security detection of model service provided in the disclosure perform security detection on the first model service based on the lifetime of the existing cache information in the first model service, to obtain the result of security detection for cache sharing of the first model service. Thus the security detection is performed on a process of KV cache sharing of a model service, an effective manner of security analysis is provided for a provider of the model service, and potential security hazards in a process of KV cache sharing in the model service is eliminated.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIG. 2 illustrates a flowchart of a process for securely sharing key-value cache of a language model according to some embodiments of the present disclosure;

FIG. 3 illustrates an example flowchart of a process for caching a key-value according to some embodiments of the present disclosure;

FIG. 4 illustrates a schematic structural block diagram of an apparatus for securely sharing key-value cache of a language model according to some embodiments of the present disclosure;

FIG. 5 illustrates a block diagram of an electronic device capable of implementing various embodiments of the present disclosure;

FIG. 6A illustrates an example schematic diagram according to embodiments of the disclosure;

FIG. 6B illustrates a schematic flowchart of an example method according to embodiments of the disclosure;

FIG. 6C illustrates a schematic diagram of an example apparatus according to embodiments of the disclosure; and

FIG. 6D illustrates a schematic diagram of a hardware structure of an example computer device according to embodiments of the disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are only for illustrative purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, managed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

Conventionally, a server may generate reply content for request content based on reusage (sharing) of a key-value(s). Specifically, when a first user sends first request content to the server, the key-value of each sub-content in the first request content may be generated, and the key-value corresponds to the status information of the first request content. If a second user also sends second request content to the server, and certain sub-content in the second request content is the same as a target sub-content in the first request content, the electronic device may reuse the key-value of the target sub-content corresponding to the first request content as the key-value of the word content in the second request content. In this case, the reply content sent by the server to the second user for the second request content may include side channel information. The second user may infer, based on the side channel information, whether the sub-content in the second request content input by the second user matches the target sub-content input by the first user, which may compromise the data privacy security of the first user. It is seen that reusage of the key-value has a certain security risk.

In addition, if reusage of the key-value is completely disabled, although these security risks can be avoided, the efficiency of information processing is significantly reduced, and the user experience deteriorates.

The embodiments of the invention provide a solution for securely sharing key-value cache of a language model. According to the solution, request content input to the language model is obtained; the protected information and non-protected information in the request content are recognized; for a first part in the non-protected information whose matched key-value is absent from a shared key-value cache of the language mode. the key-value corresponding to the first part is determined and added to the shared key-value cache; where a key-value of the protected information is not added into the shared key-value cache.

Based on this manner, in the embodiments of the present disclosure, the key-value corresponding to the first part in the non-protected information in the request content may be added to the shared key-value cache as reusable data in the shared key-value cache. Moreover, it is ensured that the key-value of the protected information is not added to the shared key-value cache, which may effectively ensure that the key-value corresponding to the protected information is not reused, thereby effectively improving the security of the privacy data of the user.

### Example Environment

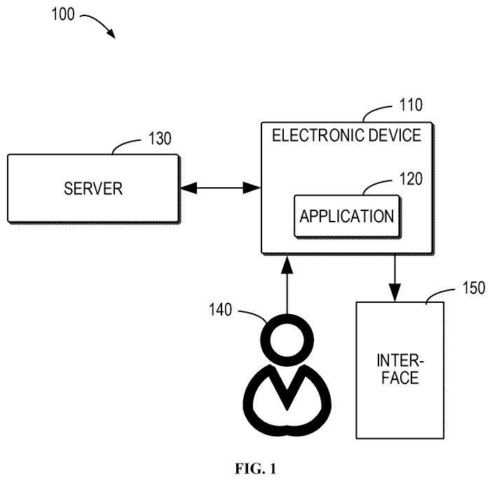

FIG. 1 illustrates a schematic diagram of an example environment 100 in which embodiments of the present disclosure can be implemented. As shown in FIG. 1, the example environment 100 may include an electronic device 110 and a server 130.

In this example environment 100, a user 140 may send request information to the server 130 based on an application 120 in the electronic device 110. The application 120 may be any suitable application including, but not limited to, a social application, a video application, and the like.

The server 130 may generate the request content for the language model based on the request information. Further, the server 130 may generate reply content for the request content based on the request content for the language model to provide the reply content to the user 140, where the language model may be deployed on the server 130.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface (such as a “wearable” circuit, etc.) for a target user.

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like.

A communication connection may be established between the electronic device 110 and the server 130. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, two devices having a data transmission relationship may implement signaling interaction by using a communication connection between the two devices.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Processes

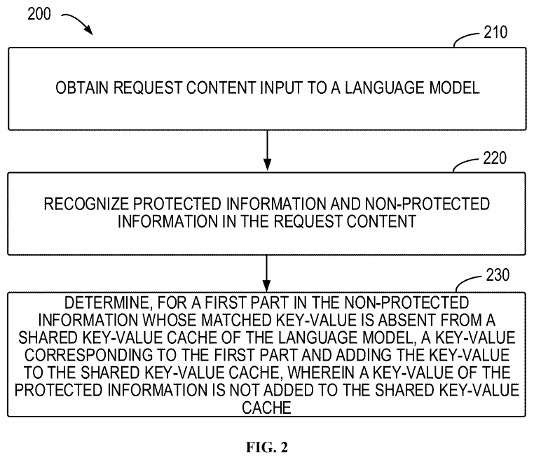

FIG. 2 shows a flowchart of a process 200 for securely sharing key-value cache of a language model according to some embodiments of the present disclosure. The process 200 may be implemented at the server 130. The process 200 is described below with reference to FIG. 1.

At block 210, the server 130 obtains the request content input to the language model.

In some embodiments, the language model may be deployed on the server 130, or may be deployed on another device other than the server 130.

In some embodiments, the request content may be text input by a user, text converted based on a voice input by the user, and the like. The request content may correspond to any appropriate form of natural language text.

At block 220, the server 130 determines to recognize protected information and non-protected information in the request content.

In some embodiments, the protected information may be any appropriate information expected to be protected, for example, which may be private data of the user. As an example, the protected information may be a phone number, a user name, an address of the user, a date, and the like. The non-protected information may be any suitable data that has no security risk, for example, may be other data other than the privacy data of the user.

In some embodiments, the server 130 may determine an entity type corresponding to the information in the request content. The entity type may be any suitable type, for example, may be a person name, a place name, an organization name, a date, or the like. Specifically, the server 130 may determine, based on a named entity recognition (NER) technology, a sample entity corresponding to information in the sample request content, and use the sample entity as the annotation information of the sample request content. Further, the server 130 may train or fine-tune the target model based on the sample entity to obtain a trained target model. Further, the server 130 may input the request content into the target model to obtain the entity type corresponding to the information in the request content output by the target model. The target model may be any suitable machine learning model. Further, the server 130 may determine the protected information and the non-protected information in the request content based on the entity type, where the entity type corresponding to the protected information may not meet the predetermined security condition, and the entity type corresponding to the non-protected information may meet the predetermined security condition.

A more refined judgment on whether information is protected or not is supported by the present disclosure based on the target model. Thereby, the accuracy of security judgment can be improved, and thus the privacy data security of the user is improved.

In some further embodiments, the server 130 may determine at least one protected content segment in the request content by providing the request content and a historical context associated with the request content to the language model. As an example, if the user interacts with the virtual object based on the target session window, the historical context may be dialogue content in the interaction process with the virtual object. Further, the server 130 may determine the protected information and the non-protected information in the request content based on a comparison between the request content and the at least one content segment. As an example, the server 130 may determine, in response to the information matching the at least one content segment in the request content, as protected information, and determine, as non-protected information, information in the request content that does not match the at least one content segment.

The present disclosure may determine the protected information and the non-protected information in the request content based on the request content and the historical context associated with the request content. Thereby, the semantic feature and the context relation can be effectively utilized, the privacy data of the indirect expression is captured, and this provides more robustness against flexible and diverse request content.

In other embodiments, the server 130 may determine the protected information and the non-protected information in the request content based on predetermined rules and patterns. For example, the server 130 may determine the protected information and the non-protected information in the request content by matching the information in the predetermined format based on the regular expression. The information in the predetermined format may include a telephone number, an identification number, a credit card number, and the like. Further, the server may determine a part of the request content that matches the information in the predetermined format as the protected information, and determine a part of the request content that does not match the information in the predetermined format as the non-protected information.

In some other embodiments, the server 130 may further determine the protected information and the non-protected information in the request content by determining, based on a set of keywords, whether each keyword included in the request content matches the set of keywords, where the set of keywords may be keywords that do not meet the security condition. Specifically, the server 130 may determine that the first keyword is the protected information in response to the first keyword in the request content matching the target keyword in the set of keywords successfully. The server 130 may determine that the second keyword is non-protected information in response to the second keyword in the request content not matching any keyword in the set of keywords successfully.

According to the present disclosure, the protected information and the non-protected information in the request content can be determined by matching based on the keyword or based on a predetermined rule. Thereby, the safety of the request content can be quickly detected, and the information processing efficiency is improved.

At block 230, the server 130 determines, for a first part in the non-protected information whose matched key-value is absent from a shared key-value cache of the language model, a key-value corresponding to the first part and adding the key-value to the shared key-value cache, where a key-value of the protected information is not added to the shared key-value cache.

In order to improve the efficiency of interaction, in some embodiments, the server 130 may construct a shared key-value cache storing a historical key-value based on the historical request content. The historical key-value representation is an intermediate representation generated based on historical request content in the historical reasoning process of the language model, and the intermediate representation is configured to optimize the calculation efficiency and the storage model state. The historical key-value is a reusable key-value, and for any historical key-value corresponding to historical information, it may support to be reused by other information matched with the historical information.

In order to ensure the security of user privacy, only the key-value corresponding to the non-protected information may be stored in the shared key-value cache, and the key-value corresponding to the protected information is not added to the shared key-value cache. In some embodiments, the key-value stored in the shared key-value cache may be a key-value corresponding to the historical token corresponding to the historical request content, that is, the shared key-value cache may store the key-value by taking the token as the granularity.

In some embodiments, the token may be sub-request content obtained after the historical request content is converted based on any appropriate dimension, which may be a word or a character in the historical request content, a punctuation mark, or the like. As an example, the historical request content may be “How do you do”, then the historical request may be converted into a token “How”, a token “do” (corresponding to the second word in the request content), a token “you”, and a token “do” (corresponding to the fourth word in the request content).

The construction process of the shared key-value cache is described below by taking the construction of the shared key-value cache by the server 130 as an example.

The server 130 may divide the historical request content input into the language model into a plurality of historical tokens. In order to protect the privacy data of the user, the server 130 may obtain at least one historical token determined from a plurality of historical tokens, where the at least one historical token is a protected token. As an example, the server 130 may determine a token of the plurality of historical tokens that does not involve the user's private data as the at least one historical token. Further, the server 130 may add the historical key-value corresponding to the at least one historical token to the shared key-value cache.

In some embodiments, when the server 130 matches the non-protected information with the shared key-value cache of the language model, the server 130 may also match the non-protected information with the granularity of the language model. Specifically, the server 130 may determine, for a plurality of tokens corresponding to the non-protected information, whether key-values matching the plurality of tokens are present in the shared key-value cache. That is, the server may determine whether the plurality of tokens match the at least one historical token.

It should be noted that, since the key-value corresponding to the historical token is not only related to the historical token itself, and is associated with the context information corresponding to the historical token in the corresponding historical request content. For the historical token of the same name, the context information corresponding to the historical token is different, and of which the different key-values are also stored in the shared key-value cache. For example, for the historical request content “How do you do”, the context information corresponding to the second word “do” is different from the context information corresponding to the fourth word “do”, although these two “do” correspond to the same word, the corresponding stored key-values in the shared key-value cache are different.

In some embodiments, the server 130 may determine, for each token corresponding to the protected information, a plurality of candidate historical tokens matching the token from the at least one historical token. The plurality of candidate historical tokens may be a plurality of historical tokens in the at least one historical token that correspond to the same name of the tokens but correspond to different historical key-values. Further, the server 130 may determine whether the first context information corresponding to the token and the second context information corresponding to the plurality of candidate tokens match. As an example, the server 130 may determine whether second context information corresponding to the plurality of candidate tokens exists in the same context information as the first context information. Further, the server 130 may determine that the token matches the target token in response to determining that the first context information matches the second context information corresponding to the target token in the plurality of candidate tokens.

For example, for the historical request content of “I really enjoy coding”, the shared key-value cache stores the historical key-value A corresponding to “enjoy”, and for the non-protected information of “I really enjoy debugging”, since the “enjoy” token in the non-protected information has the same name as “enjoy” stored in the shared key-value cache and has the same context information, the server 130 may determine the “enjoy” of the corresponding historical key-value A stored in the shared key-value cache to be the target token that matches “enjoy” in “I really enjoy debugging”.

Further, the server may determine the key-value corresponding to the first token in response to the key-value not matching the first token in the plurality of tokens in the shared key-value cache. Further, since the key-value corresponding to the first token is absent in the shared key-value cache. in order to improve the efficiency of interaction, the electronic device may add the key-value corresponding to the first token to the shared key-value cache, so as to ensure that the key-value corresponding to the first token may be used as the sharable key-value, so that the subsequent received token in the new request content performs key-value sharing.

In some embodiments, the key-value corresponding to the first part may further include first semantic information corresponding to the first part. The first semantic information represents semantic features associated with the first part in the request content, and the features may reflect context information of the tokens in the request content.

As an example, the first semantic information may indicate target context information of the first part in the request content. For example, for the request content “hi, how are you”, the first semantic information corresponding to the token “you” may indicate that the target context information corresponding to “you” is “hi, how are”.

In order to improve the probability of matching the token successfully and improve the efficiency of information processing, as another example, the first semantic information may indicate a part of the target context information in the first part. Specifically, if the key-value is stored by taking the token as the granularity, the first semantic information corresponding to the first part may be part of the target context information of each token in the first part. For example, if the first semantic information corresponding to the token “you” for the first part of “hi, how are you” may indicate that the target context information corresponding to “you” is “how are”, if a new request content of “how are you” is subsequently obtained, the key-value corresponding to the token “you” stored in the request content for “hi, how are you” in the shared key-value cache may be taken as the key-value corresponding to the token “you” in “how are you”.

In some embodiments, the first semantic information may further indicate a location of the first part in the request content. The location may represent which words or characters the first part is, in its corresponding request content, and so on. If the analysis is taken as the granularity, the first semantic information may indicate a location of each token in the first part in the request content. For example, for the request content “How do you do”, the first semantic information corresponding to the second word “do” may indicate that the “do” corresponds to the second word in the request content “How do you do”, and the first semantic information corresponding to the fourth word “do” may indicate that the “do” corresponds to the fourth word in the request content “How do you do”.

In some embodiments, since the token may be taken as the granularity for storing the key-value in the shared key-value cache, and the key-values stored in the shared key-value cache are the key-values corresponding to the non-protected tokens, thus, in order to improve the efficiency of determining the protected information and the non-protected information of the request content, the server may convert the request content into a set of tokens before recognizing the protected information and the non-protected information in the request content. As an example, each word or each character in the request content may be taken as a token. Further, the electronic device may determine from the set of tokens, a second token whose matched key-value is absent from the shared key-value cache, and where the tokens except the second token in the set of tokens (that is, from a set of tokens, the tokens whose matched key-values are present in the shared key-value cache) are non-protected information, and the key-values corresponding to the other tokens have been stored in the shared key-value cache, so it is unnecessary to determine whether the key-value needs to be stored in the shared key-value cache. Further, the electronic device may recognize the protected information and the non-protected information in the second token.

In this way, the present disclosure may effectively reduce the determination of whether the other tokens are protected information or non-protected information and the determination of whether to add the key-values corresponding to the other tokens to the shared key-value cache, which can effectively reduce the workload of the key-value cache.

In some embodiments, the electronic device may obtain, for a second part in the non-protected information whose matched key-value is present from the shared key-value cache of the language model, the key-value corresponding to the second part from the shared key-value cache. That is, the second part reuses the corresponding key-value in the shared key-value cache to serve as the key-value of the electronic device itself. Thereby effectively the efficiency of determining the key-value corresponding to the second part may be improved.

In some embodiments, since only the key-value corresponding to the non-protected information is present in the shared key-value cache, Thus, for the protected information, the corresponding key-value cannot be reused from the shared key-value cache, so the electronic device can determine the key-value of the protected information, that is, recalculate the key-value of the protected information.

Further, the electronic device may generate the reply content for the request content based on the key-value corresponding to the first part, the key-value corresponding to the second part, and the key-value of the protected information.

In some other embodiments, the server 130 may determine, in response to the request content only including the protected information and not including the non-protected information, the key-value corresponding to the request content, that is, recalculate the key-value corresponding to each token in the request content. Further, the server 130 may generate the reply content for the request content based on the key-value information corresponding to each token in the request content.

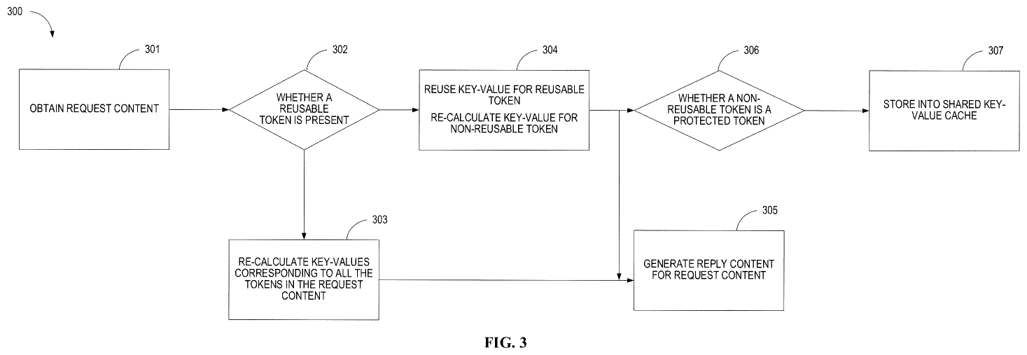

FIG. 3 illustrates an example flowchart of a process for caching a key-value according to some embodiments of the present disclosure, and is now described with reference to FIG. 3.

At block 301. the server 130 obtains the request content.

As an example, the request content is any suitable type of content for the language model, for example, text content input by the user, or text content that can be converted into voice content input by the user.

In some embodiments, the electronic device may divide the request content into a plurality of tokens.

At block 302, the server 130 determines whether a reusable token is present in the plurality of tokens.

As an example, the server 130 may determine whether a plurality of tokens match each historical token, where a key-value corresponding to each historical token is pre-stored in the shared key-value cache. Further, the server 130 may determine, in response to a certain token matching a certain target historical token stored in the shared key-value cache, that the token is reusable, specifically, the key-value of the token may reuse a key-value corresponding to the target historical token in the shared key-value cache.

In some embodiments, the server 130 may perform the operations of block 303 in response to determining that the reusable token is absent in the plurality of tokens. In other embodiments, the server 130 may perform the operations of block 304 in response to determining that the reusable token is present in the plurality of tokens.

At block 303, the server 130 recalculates the key-values corresponding to all the tokens in the request content.

In some embodiments, the server 130 determines, in response to determining that the reusable token is absent in the plurality of tokens, that the shared key-value cache does not store the key-values that can be reused for all the tokens corresponding to the request content. Therefore, the key-values corresponding to all the tokens in the request content can be recalculated based on the predetermined method.

At block 304, the server 130 reuses the key-value of the reusable token, and recalculates the key-value corresponding to the non-reusable token in the request content.

In some embodiments, the server 130 may obtain, in response to determining that a part of the reusable tokens is present, and a part of the non-reusable tokens is present in the plurality of tokens, the key-value corresponding to the reusable tokens from the shared key-value cache, and specifically, the key-value corresponding to the target token in the shared key-value cache may be determined as the key-value corresponding to the reusable token, where the reusable token matches both the name corresponding to the target token and the context information. The server 130 may also recalculate the key-values of non-reusable tokens.

At block 305, the server 130 generates reply content for the request content based on the determined key-values corresponding to the plurality of tokens.

In some embodiments, via the operation of block 303 or block 304, the server 130 may obtain the key-value corresponding to each token in the request content, so the reply content for the request content may be generated based on the key-value corresponding to each token.

At block 306, the server 130 determines whether the non-reusable token is the protected token.

As an example, the server 130 may determine whether the token is a protected token by determining whether the non-reusable token involves the privacy data of the user. The server 130 may perform the operation of 307 in response to the non-reusable token being the protected token.

At block 307, the server 130 adds the key-value corresponding to the protected token to the shared key-value cache.

As an example, the server 130 may store, in response to the non-reusable token being the protected token, the key-value corresponding to the non-reusable token in the shared key-value cache, to support determining whether the other token matches the non-reusable token. If the other token matches the non-reusable token, the server 130 may not recalculate the key-values of the other token, but directly determine the key-value corresponding to the non-reusable token as the key-value of the other token.

Based on this manner, in the embodiments of the present disclosure, the key-value corresponding to the first part in the non-protected information in the request content may be added to the shared key-value cache as the data that may be supported and reused in the shared key-value cache, and the key-value of the protected information is not added to the shared key-value cache, it may be ensured that the key-value corresponding to the protected information of the user is not reused. Thereby the security of the privacy data of the user may be effectively improved.

### Example Apparatus and Device

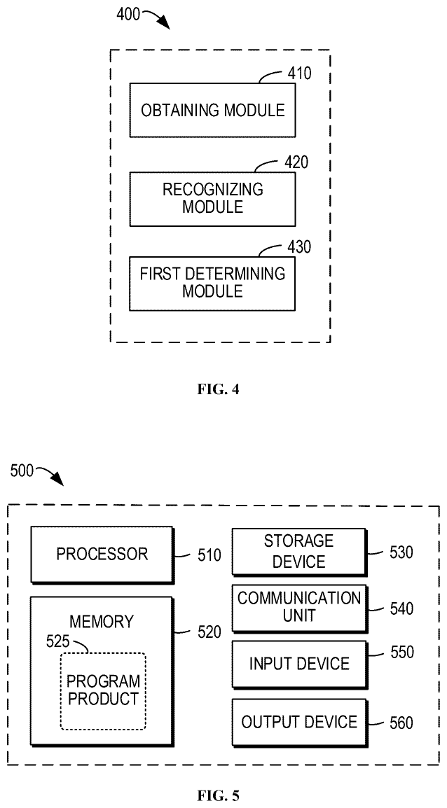

Embodiments of the present disclosure also provide a corresponding apparatus for implementing the above method or process. FIG. 4 is a schematic structural block diagram of an apparatus 400 for securely sharing key-value cache of a language model according to some embodiments of the present disclosure. The apparatus 400 may be implemented or included in the server 130 as discussed above. The various modules/components in the apparatus 400 may be implemented by hardware, software, firmware, or any combination thereof.

As shown in FIG. 4, the apparatus 400 includes an obtaining module 410 configured to obtain request content input to a language model; a recognizing module 420 configured to recognize protected information and non-protected information in the request content; and a first determining module 430 configured to determine, for a first part in the non-protected information whose matched key-value is absent from a shared key-value cache of the language model, a key-value corresponding to the first part and adding the key-value to the shared key-value cache, where a key-value of the protected information is not added to the shared key-value cache.

In some embodiments, the apparatus 400 further includes a second determining module configured to determine, for a plurality of tokens corresponding to the non-protected information, whether key-values matching the plurality of tokens are present in the shared key-value cache.

In some embodiments, the first determining module 430 is further configured to in response to that there is no key-value matching a first token in the plurality of tokens in the shared key-value cache, determine a key-value corresponding to the first token; and add the key-value corresponding to the first token to the shared key-value cache.

In some embodiments. the apparatus 400 further includes a converting module configured to convert the request content into a set of tokens; a third determining module configured to determine. from the set of tokens. a second token whose matched key-value is absent from the shared key-value cache; and the recognizing module 420 is further configured to recognize the protected information and the non-protected information in the second token.

In some embodiments, the key-value corresponding to the first part includes first semantic information corresponding to the first part, and the first semantic information indicates at least a part of target context information of the first part in the request content.

In some embodiments, the first semantic information indicates a location of the first part in the request content.

In some embodiments, the recognizing module 420 is further configured to determine an entity type corresponding to the information in the request content; and determine the protected information and the non-protected information in the request content based on the entity type.

In some embodiments, the recognizing module 420 is further configured to determine at least one protected content segment in the request content by providing the request content and a historical context associated with the request content to the language model; and determine the protected information and the non-protected information in the request content based on a comparison between the request content and the at least one content segment.

In some embodiments, the apparatus 400 further includes an obtaining module configured to obtain, for a second part in the non-protected information whose matched key-value is present in the shared key-value cache of the language model, the key-value corresponding to the second part from the shared key-value cache; a fourth determining module configured to determine the key-value of the protected information; and a generating module configured to generate reply content for the request content based on the key-value corresponding to the first part, the key-value corresponding to the second part, and the key-value of the protected information.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

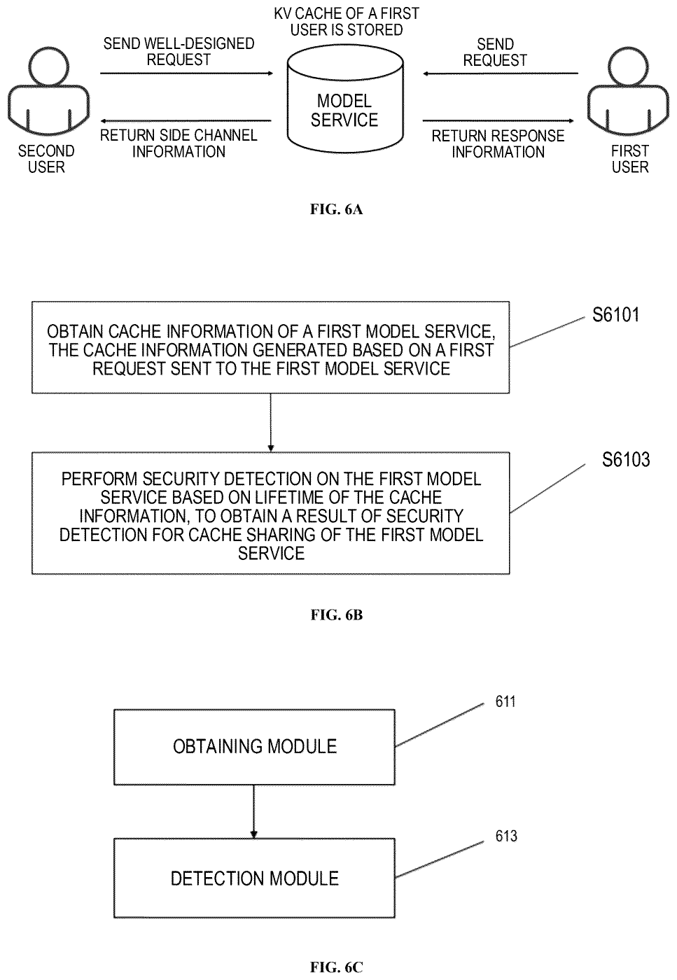

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the server 130 shown in FIG. 1.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data (e.g., training data for training) and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

Embodiments of the present disclosure further provide a method and a related device for security detection of a model service, which at least solve one of the technical problems in the related art to a certain extent.

During the inference process of the model service, when a series of input tokens are given, the model service gradually generates an output token in a self-regression manner. The inference process includes two phases: a prefill stage and an incremental decode stage.

In the prefill stage, the model service simultaneously processes all input tokens to generate a first output token.

In the incremental decode stage, the model service progressively generates the subsequent output token, each new output being dependent on the previously generated token, thereby constructing a complete response.

A key-value cache (KV cache) is a key data structure generated in an inference process of a model service. In the prefill stage and the incremental decode stage, a corresponding KV cache is generated for each generated token, which is configured for reference when a subsequent token is decoded.

The characteristics of the KV cache include:
Computing dependency: the computing of the KV cache depends on all previous tokens, and the same token may generate different KV cache in different context. For example, in the sentence “How do you do?”, the two “do” may generate the different KV cache.
Consistency: When preceding tokens are the same, the generated KV cache is also the same. This can be seen in sentences like “I really enjoy coding” and “I really enjoy debugging”. “I”, “really” and “enjoy” in the two sentences may generate the same KV cache in the same model.
Memory consumption: KV cache is a significant bottleneck in the model service because it occupies a large amount of memory resources.

KV cache plays a crucial role in the inference of model service, but also brings challenges in computing and resource management, especially in a multi-user and high-concurrency scenario.

In a high-concurrency and multi-user scenario, when all preceding tokens in the requests of a plurality of users are consistent, the generated KV cache is also the same. In this case, by means of the manner of KV cache sharing, the subsequent request may directly use the previously calculated KV cache, thereby saving time and resources for recalculation.

The key of KV cache sharing is to ensure that the preceding tokens between requests exactly match. This matching ensures that the KV cache can be reused in different requests, thereby improving the computing efficiency.

However, it is recognized in this disclosure that although the computing efficiency is improved and the memory consumption is reduced by using the KV cache sharing, there is a security problem that is ignored: a shared channel among a plurality of users is generated by the KV cache sharing, and a user can speculate questions by other users to the model service through the shared channel, thereby generating a security problem.

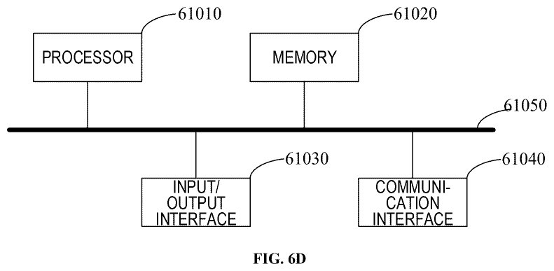

As shown in FIG. 6A, a first user sends a request to model service, and the model service generates corresponding KV cache in the model service when processing the request of the first user. This KV cache stores state information of the request of the first user.

A second user may well design a request and send the request to the model service for the purpose of attempting to reuse the KV cache of the first user. If the request of the second user reuses the KV cache of the first user, return information for the second user may carry side channel information. The side channel information may include information such as response time and power consumption of the model service. The second user may record and construct a new request and to send the new request again to the model service based on the side channel information, and further perform analysis based on the side channel information carried in the return information.

The second user may determine that a token sequence input by the second user is the same as or at least partially the same as a token sequence input by the first user by analyzing the side channel information, so that the token sequence input by the first user may be known, which affects the security of the model service.

In view of this, embodiments of the present disclosure provide a method for security detection of model service, to perform security detection on a process of KV cache sharing in a model service. An effective manner of security analysis is provided for a provider of the model service, and potential security hazards in the process of KV cache sharing in the model service is eliminated.

As shown in FIG. 6B, a method for security detection of the model service includes the following steps.

Step S6101: cache information of a first model service is obtained, and the cache information is generated based on a first request sent to the first model service.

The cache information of the first model service includes KV cache of the first model service, and the cache information is generated based on the first request sent to the first model service.

In the embodiments, the existing cache information of the first model service may be obtained, and the security of the first model service in the process of KV cache sharing may be detected based on the existing cache information.

Step S6103: security detection is performed on the first model service based on lifetime of the cache information, and a result of security detection for cache sharing of the first model service is obtained.

In the embodiments, security detection may be performed on the first model service based on the lifetime of the existing cache information in the first model service, thereby obtaining a result of security detection for cache sharing of the first model service.

In the embodiments, security detection is performed on the first model service based on the lifetime of the existing cache information in the first model service, thereby obtaining a result of security detection for cache sharing of the first model service. Thus the security detection is performed on a process of KV cache sharing in a model service, an effective manner of security analysis is provided for a provider of the model service, and potential security hazards in a process of KV cache sharing in the model service is eliminated.

In some embodiments, performing the security detection on the first model service based on the lifetime of the cache information, to obtain the result of the security detection for the cache sharing of the first model service includes: determining, in accordance with that the lifetime of the cache information is extended based on a reason of a user, that the result of security detection for cache sharing of the first model service is a failure.

In the embodiments, if the lifetime of the cache information is extended based on a reason of a user, it is indicated that the cache information is always attempted to be reused, and the reuse behavior may be caused by the attack behavior on the cache information by the user. Thus there is a security risk, and in this case, it is determined that the result of security detection for cache sharing of the first model service is a failure.

In some embodiments, the method further includes: obtaining a second request sent by a user to the first model service, and the step S6103, i.e., if the lifetime of the cache information is extended based on the reason of the user, it is determined that the result of security detection for cache sharing of the first model service is a failure, includes the following steps.

Step S6201: lifetime of the cache information is obtained.

In the embodiments, when the lifetime of the KV cache exceeds the lifetime it should have, then there may be a security problem of the KV cache sharing, and therefore the potential security risk may be determined by monitoring the lifetime of the KV cache.

Step S6203, if the lifetime of the cache information is greater than a preset lifetime threshold, an abnormality cause of the lifetime of the cache information is determined.

In the embodiments, the lifetime threshold of the KV cache in the first model service may be preset. The lifetime thresholds of the KV cache in different first model services may be different; and the lifetime thresholds of the KV cache in the same first model service may be the same or different, which is not limited in the embodiments.

In the embodiments, the lifetime of the KV cache corresponding to each first request may be compared with a preset lifetime threshold in real time, thus the KV cache with abnormal lifetime may be obtained. When the lifetime of the KV cache is greater than the preset lifetime threshold, it is indicated that the lifetime of the KV cache is abnormal. At this time, it is necessary to further determine the abnormality cause of the lifetime of the KV cache.

Step S6205, if the abnormality cause includes the lifetime of the cache information being extended based on the second request, it is determined that the result of security detection for cache sharing of the first model service is the failure.

In the embodiments, source backtracking is performed on the KV cache with the abnormal lifetime to determine the reason for the abnormal lifetime. If the abnormal lifetime is caused by the system, it may be ignored. If the abnormal lifetime is caused by the user request, for example, the user repeatedly sends the same or similar second request causing the KV cache to be reused all the time to extend the lifetime, meaning the user may be attempting to obtain the information corresponding to the KV request, then there may be a security risk of the KV cache sharing. Therefore it may be determined that the result of security detection for cache sharing of the first model service is the failure.

In some embodiments, the method further includes: determining, in response to the abnormality cause including that the cache information is not cleared based on a preset clear command, that the result of security detection for cache sharing of the first model service is the failure.

It is also possible to monitor whether the KV cache can be normally cleared. The first model service may configure a clearing condition of the KV cache, for example, regular clearing, clearing once the occupied memory exceeding the preset value. If the KV cache should be cleared but not cleared, it may be that a user prevents the execution of the clearing process in some manners, then there is a security risk of the KV cache sharing.

In the embodiments, log information corresponding to the KV cache with the abnormal lifetime may be queried, and it is determined, through the log information, whether the clear command to the KV cache is woken up or the clear command is woken up but the clear command is not executed. When it is detected that the clear command to the KV cache is not woken up or the clear command is woken up but not normally executed, there is a security risk of the KV cache sharing, so it can be determined that the result of security detection for cache sharing of the first model service is the failure.

In some embodiments, the method further includes: obtaining a third request sent by the user to the first model service; and performing security detection on the first model service based on return information of the third request, to obtain a result of security detection.

In the embodiments, the security detection may also be performed on the first model service based on the return information of the third request, and thus a security detection result may be obtained.

In some embodiments, performing the security detection on the first model service based on the return information of the third request, to obtain the result of security detection includes the following steps.

Step S6301: request processing time of the third request is obtained.

In the embodiments, the request processing time may include time between sending of the third request to the first model service and returning of the return information of the third request by the first model service, or may be time during which the first model service processes the third request and generates the return information of the third request, which is not limited in this embodiment.

Step S6303, if a number of the third requests belonging to a same user in a first preset time period is greater than a first preset number and the corresponding request processing time is less than a preset time threshold, it is determined that the result of security detection for cache sharing of the first model service is the failure.

In the embodiments, the return information of each third request may be analyzed in real time, and if the request processing time during which the first model service processes the third request is shortened obviously, for example, less than a preset time threshold, the KV cache sharing may be present for the third request.

If a large number of third requests (for example, the number of third requests is greater than the first preset number) are sent by the same user in a time period, for example, in a first preset time period, and the request processing time of the third requests has a significant reduction, it may be that the user continuously attempts to reuse the KV cache, then there is a security risk of the KV cache sharing, and therefore, it may be determined that the result of security detection for cache sharing of the first model service is the failure.

The first preset time period may be set according to a requirement of the first model service and a requirement of the user. When the first model service is a high-concurrency model service, that is, when the first model service processes the requests of a large number of users in a short time, the first preset time period may be set to a relatively short duration, for example, a few minutes, one hour, two hours, etc. When the first model service is a low-concurrency model service, the first preset time period may be set to a relatively long duration, for example, several hours, one day, several days, etc., which is not limited in this embodiment.

In some embodiments, performing the security detection on the first model service based on the return information of the third request, to obtain the result of the security detection includes the following steps.

Step S6401: return information of the third requests belonging to a plurality of users is obtained.

Step S6403, if an order of return information of the third request belonging to a target user in the plurality of users in a second preset time period is changed and a number of the third requests with an order being changed is greater than a second preset number, it is determined that the result of security detection for cache sharing of the first model service is the failure.

In the embodiments, the return information of each third request may be analyzed in real time, and if the order for the requests changes when the first model service processes the third requests of a plurality of users, the KV cache sharing may be present for the third requests.

It is assumed that users a, b, and c respectively send the third requests to the first model service in sequence, then the return information of the first model service is also returned in the sequence of a, b, and c in a normal condition.

When the sequence of the return information of the first model service changes, for example, the return information returns in the sequence of c, a, and b, it is indicated that the KV cache sharing may be present for the third request sent by the user c.

If a large number of third requests (for example, the number of third requests is greater than a second preset number) are sent by the same user (for example, the user c) in a time period, and the orders of the return information of the third requests change, it may be that the user c continuously attempt to reuse the KV cache, then there is a security risk of the KV cache sharing. Thus, it may be determined that the result of security detection for cache sharing of the first model service is the failure.

The second preset time period may be set according to a requirement of the first model service and a requirement of the user. When the first model service is a high-concurrency model service, that is, when the first model service processes the requests of a large number of users in a short time, the second preset time period may be set to a relatively short duration, for example, a few minutes, one hour, two hours, etc. When the first model service is a low-concurrency model service, the second preset time period may be set to a relatively long duration, for example, several hours, one day, several days, etc., which is not limited in the embodiments.

In some embodiments, the method further includes: obtaining a fourth request sent by a user to the first model service; and performing security detection on the first model service based on request content of the fourth request, to obtain a result of security detection.

In the embodiments, security detection may also be performed on the first model service based on the request content of the fourth request, and thus a security detection result may be obtained.

In some embodiments, performing the security detection on the first model service based on the request content of the fourth request, to obtain the result of the security detection includes the following steps.

Step S6501: requested content of the fourth request is obtained.

In the embodiments, the request content of each fourth request may be analyzed in real time to determine whether the user attempts to use the KV cache sharing to compromise the security of the first model service.

Step S6503: if in the third preset time period the request content of the fourth requests belonging to a same user is the same or similar, and/or a number of the fourth requests is greater than a third preset number, it is determined that the result of security detection for cache sharing of the first model service is the failure.

In the embodiments, real-time analysis is performed on the request content of the fourth request sent by the user. If a same user keeps sending a same or similar request in a time period, for example, in a third preset time period, it may be that the user continuously attempt to reuse the KV cache, then there is a security risk of the KV cache sharing. Thus, it may be determined that the result of security detection for cache sharing of the first model service is the failure.

For example, when the request content of a plurality of fourth requests of the user is “How do you do?” “How do you?” “How you do?” “What do you do?” and the other similar contents, the user may continuously attempt to reuse the corresponding KV cache, and there is a security risk of the KV cache sharing.

The similarity between the request contents of the plurality of fourth requests may be calculated, and when the similarity is greater than the preset threshold, it is determined that the plurality of fourth requests are similar requests.

In the embodiments, real-time analysis is performed on the request content of the fourth request sent by the user. If a large number of requests are sent by the same user in a time period, for example, in a third preset time period, it may be that the user continuously attempts to reuse the KV cache, then there is a security risk of the KV cache sharing. Thus, it may be determined that the result of security detection for cache sharing of the first model service is the failure.

In the embodiments, real-time analysis is performed on the request content of the fourth request sent by the user. If a same user keeps sending a same or similar request in a time period, for example, in a third preset time period, it may be that the user continuously attempts to reuse the KV cache, then there is a security risk of the KV cache sharing. Thus, it may be determined that the result of security detection for cache sharing of the first model service is the failure.

The third preset time period may be set according to a requirement of the first model service and a requirement of the user. When the first model service is a high-concurrency model service, that is, when the first model service processes the requests of a large number of users in a short time, the third preset time period may be set to a relatively short duration, for example, a few minutes, one hour, two hours, etc. When the first model service is a low-concurrency model service, the third preset time period may be set to a relatively long duration, for example, several hours, one day, several days, or the like, which is not limited in this embodiment.

In some embodiments, performing the security detection on the first model service based on the request content of the fourth request, to obtain the result of the security detection includes the following steps.

Step S6601: requested content of the fourth request is obtained.

Step S6603: a request parameter set by a user in the request content is obtained.

Step S6605: in response to the request parameter set by the user satisfying a preset condition, it is determined that the result of security detection for cache sharing of the first model service is the failure.

In the embodiments, the request content of each fourth request may be analyzed in real time to determine whether there are some unreasonable, uncommon, or extreme request parameter values in the request content of the fourth request. If there are some unreasonable, uncommon or extreme request parameter values, it may be that the user attempts to use the KV cache sharing to compromise the security of the first model service.

Therefore, in the embodiments, the request parameter set by the user in the request content of the fourth request may be obtained, and the request parameter set by the user is compared with the preset condition. If the preset condition is satisfied, it is indicated that there are some unreasonable, uncommon, or extreme request parameter values, then there is a security risk of the KV cache sharing. Thus, it may be determined that the result of security detection for cache sharing of the first model service is the failure.

The request parameter set by the user satisfying the preset condition includes at least one of: a length of return information of the fourth request being less than a preset value; or cache information generated based on the fourth request not stored in the first model service.

In general, the user wants the model service to provide more detailed, more accurate, richer return information. If the return information is set to be small by the request parameter set by the user attached in the request content of the request sent by the user, for example, the length of the return information of the fourth request is less than the preset value, it is indicated that the user may not use the model service normally, but in an attempt to reuse the KV cache, then there is a security risk of the KV cache sharing. Thus, it may be determined that the result of security detection for cache sharing of the first model service is the failure.

Generally, when sending a request to a model service, the user usually does not consider whether the request will generate KV cache in the model service. If in the request content of the request sent by the user, the attached request parameter set by the user sets that it request to not store the corresponding KV cache in the first model service, the user may be attempting to reuse the KV cache and not expect to store the KV cache corresponding to the request of the user itself, then there is the security risk of the KV cache sharing. Thus, it may be determined that the result of security detection for cache sharing of the first model service is the failure.

In some embodiments, the method further includes: generating alarm information based on the result of the security detection. The alarm information includes at least one of request content of the fourth request with the result of the security detection being the failure, return information of the third request, information of a user to which the request belongs, or an alarm reason.

In the embodiments, when the result of security detection is the failure, alarm information may be generated.

The alarm information may include at least one of request content of the fourth request that the result of the security detection is the failure, return information of the third request, information of a user to which the request belongs, or an alarm reason. The alarm reason may include that the lifetime of the KV cache is caused to be extended due to a user request or that it is not normally cleared, that a user reuses the KV cache a plurality times in a preset duration, that a user sends the same or similar requests a plurality times in a preset duration to attempt to reuse the KV cache, that the request content includes an abnormal parameter, and the like.

In the embodiments, through the alarm information, a user, content, a location in the model service, a specific reason, and the like for which a security risk of KV cache sharing may be present may be provided to the user, so that the user may conduct further analysis and handling based on the alarm information to maintain the security of the first model service.

It should be noted that the method in the embodiments of the present disclosure may be performed by a single device, for example, a computer or a server. The method in this embodiment may also be applied to a distributed scenario, and a plurality of devices cooperate to complete. In this distributed scenario, one of the plurality of devices may perform only one or more steps in the method in the embodiments of the present disclosure, and the plurality of devices interact with each other to complete the method.

It should be noted that some embodiments of the present disclosure are described above. Other embodiments are within the scope of the attached claims. In some cases, the acts or steps recited in the claims may be performed in a different sequence than in the above embodiments and still achieve the desired results. Additionally, the processes depicted in the figures do not necessarily require a particular sequence or sequential order shown to achieve the desired results. In certain embodiments, multi-task and parallel processing are also possible or may be advantageous.

Based on the same inventive concept, corresponding to the foregoing embodiment methods, the present disclosure further provides an apparatus for security detection of model service.

Referring to FIG. 6C, an apparatus for security detection of a model service includes the following modules.

An obtaining module 611 is configured to obtain cache information of a first model service, the cache information generated based on a first request sent to the first model service.

A detection module 613 is configured to perform security detection on the first model service based on lifetime of the cache information, to obtain a result of security detection for cache sharing of the first model service.

In some embodiments, the detection module 613 is configured to determine, in accordance with that the lifetime of the cache information is extended based on a reason of a user, that the result of security detection for cache sharing of the first model service is a failure.

In some embodiments, the detecting module 613 is further configured to obtain a second request sent by the user to the first model service; the detecting module 613 is further configured to obtain the lifetime of the cache information; determine, in accordance with that the lifetime of the cache information is greater than a preset lifetime threshold, an abnormality cause of the lifetime of the cache information; and determine, in accordance with that the abnormality cause comprises the lifetime of the cache information being extended based on the second request, that the result of security detection for cache sharing of the first model service is the failure.

In some embodiments, the apparatus is further configured to determine, in response to the abnormality cause comprising that cache information is not cleared based on a preset clear command, that the result of security detection for cache sharing of the first model service is the failure.

In some embodiments, the detection module 613 is further configured to obtain a third request sent by a user to the first model service; and perform security detection on the first model service based on return information of the third request, to obtain a result of security detection.

In some embodiments, the detection module 613 is further configured to obtain request processing time of the third request; and determine, in accordance with that a number of the third requests belonging to a same user in a first preset period is greater than a first preset number and the corresponding request processing time is less than a preset time threshold, that the result of security detection for cache sharing of the first model service is the failure.

In some embodiments, the detection module 613 is further configured to obtain return information of the third requests belonging to a plurality of users; and determine, in accordance with that an order of return information of the third request belonging to a target user in the plurality of users in a second preset time period is changed and a number of the third requests with an order being changed is greater than a second preset number, that the result of security detection for cache sharing of the first model service is the failure

In some embodiments, the detection module 613 is further configured to obtain a fourth request sent by a user to the first model service; and perform security detection on the first model service based on request content of the fourth request, to obtain a result of security detection.

In some embodiments, the detection module 613 is further configured to obtain the request content of the fourth request; and determine, in accordance with that in a third preset time period the request content of the fourth requests belonging to a same user is the same or similar, and/or a number of the fourth requests is greater than a third preset number, that the result of security detection for cache sharing of the first model service is the failure.

In some embodiments, the detection module 613 is further configured to obtain request content of the fourth request; obtain a request parameter set by a user in the request content; and determine, in response to the request parameter set by the user satisfying a preset condition, that the result of security detection for cache sharing of the first model service is the failure.

In some embodiments, the request parameter set by the user satisfying the preset condition comprises at least one of: a length of return information of the fourth request being less than a preset value; or cache information generated based on the fourth request not stored in the first model service.

For convenience of description, the above apparatus is divided into various modules according to the functions, so that the apparatus may be described respectively when the above apparatus is described. It is obviously that the functions of the modules may be implemented in one or more software and/or hardware when implementing the present disclosure.

The apparatus of the foregoing embodiments is configured to implement the corresponding method in any of the foregoing embodiments, and has the beneficial effects of the corresponding method embodiments, and details are not described herein again.

Based on the same inventive concept, corresponding to the foregoing embodiment methods, the present disclosure further provides an electronic device, including a memory, a processor, and a computer program stored in the memory and executable on the processor, where when the processor executes the program, the method of any of the foregoing embodiments is implemented.

FIG. 6D is a schematic diagram of a more specific hardware structure of an electronic device according to the embodiments. The device may include a processor 61010, a memory 61020, an input/output interface 61030, a communication interface 61040, and a bus 61050. The processor 61010, the memory 61020, the input/output interface 61030, and the communications interface 61040 implement. through the bus 61050, a communication connection with each other inside the device.

The processor 61010 may be implemented by using a general-purpose central processing unit (CPU), a microprocessor, an application specific integrated circuit (ASIC), or one or more integrated circuits. And the processor 61010 is configured to execute related programs to implement the technical solutions provided in embodiments of the present disclosure.

The memory 61020 may be implemented in a form of a ROM (Read Only Memory), a Random Access Memory (RAM), a static storage device, a dynamic storage device, or the like. The memory 61020 may store an operating system and other applications, and when implementing the technical solutions provided in embodiments of the present disclosure by using software or firmware, related program code is stored in the memory 61020 and invoked to executing by the processor 61010.

The input/output interface 61030 is configured to connect the input/output module to implement information input and output. The input/output/module may be configured as a component in the device (not shown in the figure), or may be externally connected to the device to provide a corresponding function. The input device may include a keyboard, a mouse, a touch screen, a microphone, various sensors, etc., and the output device may include a display, a speaker, a vibrator, an indicator light, and the like.

The communications interface 61040 is configured to connect a communication module (not shown in the figure), to implement communication interaction between this device and another device. The communication module may implement communication in a wired manner (for example, a USB or a network cable), or may implement communication in a wireless manner (for example, a mobile network, a Wi-Fi, a Bluetooth, and the like).

The bus 61050 includes a path to transmit information between various components of the device (such as the processor 61010, the memory 61020, the input/output interface 61030, and the communication interface 61040).

It should be noted that although the foregoing device only shows the processor 61010, the memory 61020, the input/output interface 61030, the communications interface 61040, and the bus 61050, in a specific implementation process, the device may further include other components necessary to implement normal running. In addition, those skilled in the art may understand that the foregoing device may also include only components necessary for implementing the solutions in the embodiments of the present specification, and does not necessarily include all components shown in the figure.

The electronic device of the foregoing embodiment is configured to implement the corresponding method in any of the foregoing embodiments, and has the beneficial effects of the corresponding method embodiments, and details are not described herein again.

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for securely sharing key-value cache of a language model, comprising:
obtaining request content input to a language model;
recognizing protected information and non-protected information in the request content; and
determining, for a first part in the non-protected information whose matched key-value is absent from a shared key-value cache of the language model, a key-value corresponding to the first part and adding the key-value to the shared key-value cache,
wherein a key-value of the protected information is not added to the shared key-value cache.

2. The method of claim 1, further comprising:
determining, for a plurality of tokens corresponding to the non-protected information, whether key-values matching the plurality of tokens are present in the shared key-value cache.

3. The method of claim 2, wherein determining, for the first part in the non-protected information whose matched key-value is absent from the shared key-value cache of the language model, the key-value corresponding to the first part and adding the key-value corresponding to the first part to the shared key-value cache comprises:
in response to that there is no key-value matching a first token in the plurality of tokens in the shared key-value cache,
determining a key-value corresponding to the first token; and
adding the key-value corresponding to the first token to the shared key-value cache.

4. The method of claim 1, wherein, before recognizing the protected information and the non-protected information in the request content, the method further comprises:
converting the request content into a set of tokens; and
determining, from the set of tokens, a second token whose matched key-value is absent from the shared key-value cache, and
wherein recognizing the protected information and the non-protected information in the request content comprises:
recognizing the protected information and the non-protected information in the second token.

5. The method of claim 1, wherein the key-value corresponding to the first part comprises first semantic information corresponding to the first part, and the first semantic information indicates at least a part of target context information of the first part in the request content.

6. The method of claim 5, wherein the first semantic information indicates a location of the first part in the request content.

7. The method of claim 1, wherein recognizing the protected information and the non-protected information in the request content comprises:
determining an entity type corresponding to the information in the request content; and
determining the protected information and the non-protected information in the request content based on the entity type.

8. The method of claim 1, wherein recognizing the protected information and the non-protected information in the request content comprises:
determining at least one protected content segment in the request content by providing the request content and a historical context associated with the request content to the language model; and
determining the protected information and the non-protected information in the request content based on a comparison between the request content and the at least one content segment.

9. The method of claim 1, further comprising:
obtaining, for a second part in the non-protected information whose matched key-value is present in the shared key-value cache of the language model, the key-value corresponding to the second part from the shared key-value cache;
determining the key-value of the protected information; and
generating reply content for the request content based on the key-value corresponding to the first part, the key-value corresponding to the second part, and the key-value of the protected information.

10. A method for security detection of a model service, comprising:
obtaining cache information of a first model service, the cache information generated based on a first request sent to the first model service; and
performing security detection on the first model service based on lifetime of the cache information, to obtain a result of security detection for cache sharing of the first model service.

11. The method of claim 10, wherein performing the security detection on the first model service based on the lifetime of the cache information, to obtain the result of the security detection for the cache sharing of the first model service comprises:
determining, in accordance with that the lifetime of the cache information is extended based on a reason of a user, that the result of security detection for cache sharing of the first model service is a failure.

12. The method of claim 11, further comprising: obtaining a second request sent by the user to the first model service; and
determining, in accordance with that the lifetime of the cache information is extended based on the reason of the user, that the result of security detection for cache sharing of the first model service is the failure, comprising:
obtaining the lifetime of the cache information;
determining, in accordance with that the lifetime of the cache information is greater than a preset lifetime threshold, an abnormality cause of the lifetime of the cache information; and
determining, in accordance with that the abnormality cause comprises the lifetime of the cache information being extended based on the second request, that the result of security detection for cache sharing of the first model service is the failure.

13. The method of claim 12, further comprising:
determining, in response to the abnormality cause comprising that cache information is not cleared based on a preset clear command, that the result of security detection for cache sharing of the first model service is the failure.

14. The method of claim 10, further comprising:
obtaining a third request sent by a user to the first model service; and
performing security detection on the first model service based on return information of the third request, to obtain a result of security detection.

15. The method of claim 14, wherein performing the security detection on the first model service based on the return information of the third request, to obtain the result of security detection comprises:
obtaining request processing time of the third request; and
determining, in accordance with that a number of the third requests belonging to a same user in a first preset period is greater than a first preset number and the corresponding request processing time is less than a preset time threshold, that the result of security detection for cache sharing of the first model service is the failure.

16. The method of claim 14, wherein performing the security detection on the first model service based on the return information of the third request, to obtain the result of the security detection comprises:
obtaining return information of the third requests belonging to a plurality of users; and
determining, in accordance with that an order of return information of the third request belonging to a target user in the plurality of users in a second preset time period is changed and a number of the third requests with an order being changed is greater than a second preset number, that the result of security detection for cache sharing of the first model service is the failure.

17. The method of claim 10, further comprising:
obtaining a fourth request sent by a user to the first model service; and
performing security detection on the first model service based on request content of the fourth request, to obtain a result of security detection.

18. The method of claim 17, wherein performing the security detection on the first model service based on the request content of the fourth request, to obtain the result of the security detection comprises:
obtaining the request content of the fourth request; and
determining, in accordance with that in a third preset time period the request content of the fourth requests belonging to a same user is the same or similar, and/or a number of the fourth requests is greater than a third preset number, that the result of security detection for cache sharing of the first model service is the failure.

19. The method of claim 17, wherein performing the security detection on the first model service based on the request content of the fourth request, to obtain the result of the security detection comprises:
obtaining request content of the fourth request;
obtaining a request parameter set by a user in the request content; and
determining, in response to the request parameter set by the user satisfying a preset condition, that the result of security detection for cache sharing of the first model service is the failure.

20. An electronic device comprising a memory, a processor, and a computer program, the computer program being stored on the memory and executable on the processor, the processor, when executes the program, implementing acts comprising:
obtaining request content input to a language model;
recognizing protected information and non-protected information in the request content;
determining, for a first part in the non-protected information whose matched key-value is absent from a shared key-value cache of the language model, a key-value corresponding to the first part and adding the key-value to the shared key-value cache,
wherein a key-value of the protected information is not added to the shared key-value cache.
